(19) United States
(12) Patent Application Publication
(10) Pub. No.: US 2014/0197155 A1
(43) Pub. Date: Jul. 17, 2014

(54) HEATER CONTROL APPARATUS

(71) Applicant: TOYOTA BOSHOKU KABUSHIKI KAISHA, Aichi-ken (JP)

(72) Inventors: Tsukasa TAKAHASHI, Aichi-ken (JP); Kenichi MIZUNO, Aichi-ken (JP)

(73) Assignee: TOYOTA BOSHOKU KABUSHIKI KAISHA, Aichi-ken (JP)

(21) Appl. No.: 14/154,371

(22) Filed: Jan. 14, 2014

(30) Foreign Application Priority Data
Jan. 15, 2013 (JP) 2013-004885

(51) Int. Cl. H05B 1/02

(52) U.S. Cl. CPC H05B 1/0238
USPC 219/498

(57) ABSTRACT

There is provided a heater control apparatus for controlling a heat generation amount of a heater including a heating element which is provided in a seat and which has a positive or negative temperature coefficient of resistance. The heater control apparatus includes a resistance detection unit which detects an electricity amount which corresponds to a resistance value of the heating element, and a control unit which increases or decreases an electric energizing amount supplied to the heating element according to the resistance value obtained by the resistance detection unit.

### BACKGROUND OF THE INVENTION

1. Field of the Invention

The present invention relates to a heater control apparatus, and more particularly, to a heater control apparatus which can obtain a constant heat generation amount even though a resistance value of a heating element used in a heater changes and which can fully utilize a capacity of a power supply for supplying electric power to the heater.

2. Description of the Related Art

Conventionally, a seat heater is used in a vehicle such as an automobile to supply warming heat to an occupant thereof. The seat heater includes a heater provided in a seat cushion portion and a backrest of a seat of the vehicle. In the seat heater, the heater is controlled to reach a set temperature by switching on and off power supply of the heater or changing an amount of electric power which is supplied to the heater according to the temperature thereof. For example, the heater is energized continuously until the heater is heated to a set temperature, and after the heater reaches the set temperature, the power supply is switched on and off according to the temperature thereof such that the temperature of the heater is maintained within a certain temperature range.

On the other hand, since a capacity of a power supply installed in a vehicle is limited, electric power (electric current) which is supplied to a seat heater needs to be controlled so as to fall within the capacity of the power supply.

Incidentally, there has been known a control apparatus which controls electric power which is supplied to the heater through a pulse width modulation (PWM). For example, JP-A-2010-105487 discloses a vehicle power supply apparatus which supplies electric power generated in a vehicle alternator to the seat heater. In this vehicle power supply apparatus, the heater is continuously energized (100% of the duty ratio) after the seat heater is switched on until the heater reaches a set temperature. Then, after the heater reaches the set temperature, the power supply is switched on and off or the duty ratio is controlled such that the seat heater can maintain the set temperature.

In the seat heater control apparatus or the vehicle power supply apparatus described in JP-A-2010-105487, the temperature of the heater is increased as quickly as possible by energizing the heater continuously until the heater reaches the set temperature, and after the heater reaches the set temperature, the power supply is switched on and off or the duty ratio of the PWM is changed such that the temperature of the heater stays in the certain temperature range. However, in general, a resistance value of a resistance heating element used in the heater changes with temperature.

For example, FIGS. 7A and 7B show changes in temperature and resistance value of a resistance heating element and a change in electric power which is actually supplied to the resistance heating element when a power supply of a constant voltage is kept on from the activation of the heater in a case where a material having a positive temperature coefficient of resistance is used as the resistance heating element. After the start of power supply, the resistance value of the resistance heating element increases as the temperature thereof increases, and therefore, an amount of supplied electric current decreases. As a result, since the amount of electric power supplied to the resistance heating element decreases, (in an area denoted by reference numeral 9 in FIG. 7A), the heat generation amount decreases accordingly. On the other hand, in a case where the resistance heating element has a negative temperature coefficient of resistance, the resistance value decreases as the temperature increases, and with the applied voltage remaining constant, the supplied electric power would increase.

As described above, since the resistance value of the resistance heating element changes with change in temperature of the resistance heating element, for example, when the temperature of the heater is controlled with the same duty ratio through the PWM control, the heat generation amount changes as the temperature changes, which causes a problem that the temperature of the heater cannot be controlled accurately.

In addition, in the above described seat heater, the resistance heating element is controlled such that the electric current which flows to the resistance heating element falls within the capacity of the power supply at any temperature irrespective of the value of the temperature coefficient of resistance of the resistance heating element or irrespective of whether the resistance heating element has the positive or negative temperature coefficient of resistance. However, since the amount of electric power supplied to the resistance heating element changes according to the temperature thereof as described above, a problem that the supplying capability of the power supply cannot be fully utilized at every temperature of the resistance heating element. For example, as shown in FIGS. 7A and 7B, in a case of supplying an amount of electric power which is set close to the supplying capability of the power supply at a low temperature, only an amount of electric power which is lower than the supplying capability of the power supply can be supplied at a higher temperature, and therefore, the heating performance is reduced.

### SUMMARY OF THE INVENTION

The present invention has been made in view of the above circumstances, and an object of the present invention is to provide a heater control apparatus which can obtain a constant heat generation amount even though a resistance value of a heating element used in a heater changes and which can fully utilize a capacity of a power supply for supplying electric power to the heater.

According to an illustrative embodiment of the present invention, there is provided a heater control apparatus for controlling a heat generation amount of a heater including a heating element which is provided in a seat and which has a positive or negative temperature coefficient of resistance, the heater control apparatus comprising: a resistance detection unit which detects an electricity amount which corresponds to a resistance value of the heating element; and a control unit which increases or decreases an electric energizing amount supplied to the heating element according to the resistance value obtained by the resistance detection unit.

According to the above configuration, even though the resistance value of the heating element changes as the temperature thereof changes, a constant amount of electric power can be supplied irrespective of the temperature of the heating element by controlling the electric energizing amount supplied to the heating element according to a change in the resistance value, whereby the temperature of the seat heater can be controlled accurately. In addition, since a constant heat generation amount can be obtained even though the resistance value of the heating element changes, it is possible to fully utilize the capacity of the power supply for supplying electric power to the heater, whereby the hearer can reach a target temperature as quickly as possible irrespective of the temperature of the heater.

In the above heater control apparatus, the heating element may have a positive temperature coefficient of resistance, and the control unit may control electric power supply to the heating element through a PWM control and compensate for the electric energizing amount supplied to the heating element by changing a duty ration to increase when the resistance value obtained by the resistance detection unit is increased.

According to the above configuration, even though the resistance value increases as the temperature of the heating element increases, the duty ratio is controlled so as to compensate for the reduction in the electric power supply due to the increase in resistance value. Therefore, the change in the electric power supply to the heating element can be suppressed irrespective of the temperature of the heating element. Accordingly, even though the temperature of the heater increases, the reduction in the electric power supply can be suppressed, and it is possible to reach the target temperature in a shorter period of time than through the related-art heater control.

In the above heater control apparatus, the heating element may have a negative temperature coefficient of resistance, and the control unit may control electric power supply to the heating element through a PWM control and suppress the electric energizing amount supplied to the heating element by changing a duty ratio to decrease when the resistance value obtained by the resistance detection unit is decreased.

According to the above configuration, even though the resistance value decreases as the temperature of the heating element increases, the duty ratio is controlled such that the electric power supply is not increased by the decrease in resistance value, and therefore, it is possible to suppress the change in the electric power supply to the heating element irrespective of the temperature thereof. In addition, since the maximum amount of electric power within the capacity of the power supply can be supplied also when the temperature of the heater is low, it is possible to reach the target temperature in a shorter period of time than through the related-art heater control.

In the above heater control apparatus, the heater may be supplied with electric power from a predetermined power supply, and the control unit may be capable of supplying, to the heating element, a maximum amount of electric power which is determined within a capacity of the power supply when the heating element has a predetermined resistance value.

According to the above configuration, the maximum amount of electric power of the heating element can be supplied at all times irrespective of the temperature thereof by adopting the configuration that the maximum electric power can be supplied to the heating element at the predetermined temperature (an upper limit temperature of the usable temperature range when the temperature coefficient of resistance of the heating element is positive or at a lower limit temperature of the usable temperature range when the temperature coefficient of resistance is negative). Therefore, it is possible to fully utilize the capacity of the power supply irrespective of the temperature of the heating element, and the heating element can be made to reach the target temperature more quickly than with the related-art heater control.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a schematic sectional view showing a configuration of a heater control apparatus which is applied to a vehicle seat heater;

FIGS. 2A and 2B show graphs describing changes in temperature and resistance value of a heating element, and changes in voltage and electric power supplied to the heating element in a heater control for the heating element having a positive temperature coefficient of resistance;

FIGS. 3A and 3B shows graphs describing changes in temperature and resistance value of a heating element, and changes in voltage and electric power supplied to the heating element in a heater control for the heating element having a negative temperature coefficient of resistance;

FIGS. 4A and 4B show graphs describing changes in temperature and resistance value of a heating element, and changes in voltage and electric power supplied to the heating element in another heater control for the heating element having a positive temperature coefficient of resistance;

FIG. 5 is a graph showing actual measured values of temperature and resistance value of a heating element having a positive temperature coefficient of resistance;

FIG. 6 is a graph showing actual measured values of temperature and resistance value of a heating element having a negative temperature coefficient of resistance; and

FIGS. 7A and 7B show graphs describing changes in temperature and resistance value of a heating element, and changes in voltage and electric power supplied to the heating element in a related-art heater control.

### DETAILED DESCRIPTION

Hereinafter, referring to the drawings, illustrative embodiments of the present invention will be described in detail.

Contents described below constitute an example which describes a typical illustrative embodiment of the present invention and are intended to provide an explanation by which the principle and conceptional characteristics of the present invention can be understood most effectively and without any difficulty. In this respect, it is not intended that structural details of the present invention are described more than required for basic understanding of the present invention. Thus, how several forms of the present invention are actually embodied will be appreciated by those skilled in the art with the explanation together with the drawings.

A heater control apparatus controls temperature of a heater which is provided in a seat by controlling a heat generation amount thereof The heater is configured by a heating element having a positive or negative temperature coefficient of resistance.

There is no limitation on a seat in which the heater control apparatus is provided, and the heater control apparatus can be applied, for example, to various seats which are placed in a vehicle, a room and the like. The heater control apparatus can preferably be used as a control apparatus for a heater provided in a vehicle seat (a vehicle seat heater) or part of a control apparatus thereof.

The heater control apparatus includes a resistance detection unit which detects an electricity amount which corresponds to a resistance value of the heating element and a control unit which increases or decreases an electric energizing amount supplied to the heating element according to the resistance value obtained by the resistance detection unit.

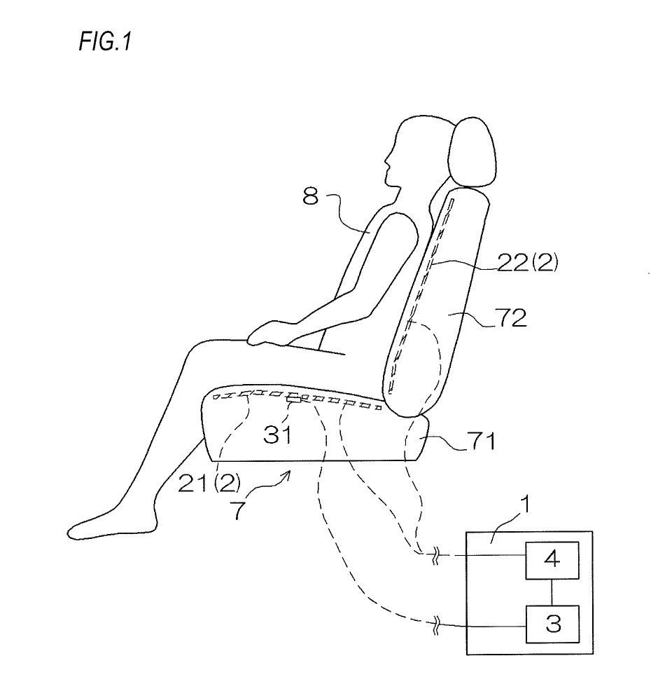

FIG. 1 shows an exemplary configuration of a vehicle seat 7 which is provided in a vehicle such as an automobile, a heater 2 which is provided in the seat 7 and a heater control apparatus 1. The vehicle seat 7 includes a seat cushion portion 71 and a backrest portion 72. The heater 2, which is a heating element for warming a body of an occupant 8 seated in the vehicle seat 7, is provided in the vehicle seat 7. In the seat 7 of this illustrative embodiment, a heater 21 is provided in a surface layer portion of the seat cushion portion 71, and a heater 22 is provided in a surface layer portion of the back rest portion 72. These surface layer portions are portions where the occupant 8 is in contact therewith. The heater control apparatus 1 may include an operation switch with which the occupant 8 switches on and off a power supply for the heater 2 and a control portion with which the occupant 8 sets a target temperature (not shown).

The heater control apparatus 1 includes a resistance detection unit 3 which measures a resistance value of each of the heaters 21, 22, and a control unit 4 which controls the amount of electric power supplied to the heater 2 (21, 22 and the like). The control unit 4 controls the electric energizing amount supplied to the heater 2, and the heat generation amount changes according to the amount of electric energy supplied to the heater 2.

The heater 2 includes the heating element and is preferably provided in the surface layer portions of the seat where the occupant is in contact therewith. The surface layer portions may include a seat cover which is provided integrally with the seat so as to cover an external surface of the seat. For example, the heaters 21, 22 may be provided, respectively, between cushion members which are provided in interiors of the seat cushion portion 71 and the backrest portion 72 and the seat cover.

In the case of the vehicle seat, power supplies for the heater control apparatus 1 and the heaters 21, 22 can be fed from an on-board power supply such as an on-board generator (also referred to as an alternator) or a battery which is installed in the vehicle.

There is no specific limitation on a material for the heating element, and hence, an arbitrary material can be used. For example, the material having a positive temperature coefficient of resistance may be stainless steel, copper, nichrome, tungsten and the like. The material having a negative temperature coefficient of resistance may be carbon and the like. Further, there is no specific limitation on shape and dimensions of a heating element which configures the heater. For example, a heating element having a liner shape or surface shape may be used.

FIG. 5 shows, as an example, actual measured values of temperature and resistance value of a heating element having a positive temperature coefficient of resistance. In this example, a stainless steel strand having a diameter of 28 μm and a length of 30 cm is used. It is observed that the resistance value increases by 3.0% when the heating element is heated to a temperature of +80° C., compared with when the heating element is at a temperature of −20° C.

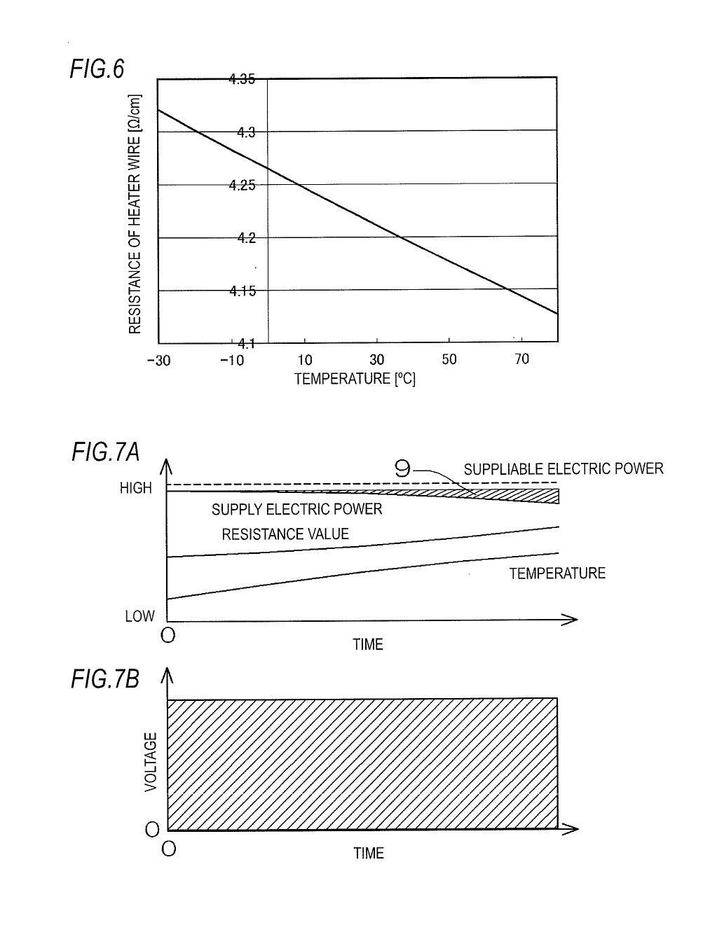

In addition, FIG. 6 shows, as an example, actual measured values of temperature and resistance value of a heating element having a negative temperature coefficient of resistance. In this example, a carbon strand having fineness of 66 tex (g/1000m) and a length of 26 cm is used. It is observed that the resistance value decreases by about 4.4% when the heating element is heated to a temperature of +80° C., compared with when the heating element is at a temperature of −20° C.

The resistance detection unit 3 is configured to detect an electricity amount which corresponds to a resistance value of the heating element. There is no specific limitation on an electricity amount to be detected. Hence, it may be configured to detect an electricity amount which can be converted into a resistance value of the heating element and measured by using the configuration and detection method which are used in a known resistance detection unit. That is, the electricity amount may be a voltage or electric current which is supplied to the heating element, a temperature and the like of the heating element.

For example, when the voltage of the power supply which supplies electric power to the heating element elements remains constant, it is possible to calculate a resistance value of the heating element by measuring an electric current which flows to the heating element. Further, it may be possible to detect a resistance value of the heating element from a measured value which is obtained by measuring the temperature of the heating element with a temperature detection element such as a thermistor. That is, if the temperature coefficient of resistance of the heating element and a resistance value of the heating element at respective temperatures are already known, the temperature of the heating element can be measured as an electricity amount which corresponds to a resistance value of the heating element, and the measured temperature can then be converted into the resistance value.

The control unit 4 is configured to calculate a resistance value of the heating element based on the electricity amount detected by the resistance detection unit 3 so as to increase or decrease the electric energizing amount supplied to the heating element according to a change in the resistance value. The control unit 4 may include only hardware or may include both hardware and software by using a microprocessor or the like. Further, the control unit 4 may be configured as part of an electronic control unit (ECU).

The electric energizing amount supplied to the heating element means amounts of voltage, electric current, time and the like which are used to energize the heating element. Control methods for controlling the electric energizing amount supplied to the heating element may be selected arbitrarily. For example, the electric energizing amount may be controlled by performing an on/off control, a pulse width modulation (PWM) control, a voltage control, an electric current control and the like by the microprocessor.

Further, the operation switch and the control portion may be connected to the control unit 4 so as to control the heater based on the states thereof.

Next, the method and operation of controlling the heater control apparatus will be described.

The control unit of the heater control apparatus of this illustrative embodiment obtains the resistance value of the heating element based on the electricity amount detected by the resistance detection unit and controls the electric energizing amount supplied to the heating element so as to increase or decrease according to a change in the resistance value. By controlling the electric energizing amount in the manner described above, it is possible to allow a predetermined amount of electric power to be supplied to the heating element irrespective of the resistance value (the temperature) of the heating element. Namely, it is possible to control the heater such that when the heating element is energized for a certain period of time, a constant amount of electric power is supplied to the heating element and the heat generation amount of the heating element remains constant, irrespective of the temperature of the heating element.

As described above, any control method can be adopted to control the electric energizing amount supplied to the heating element. In the following description, the control unit 4 will be described as controlling the electric energizing amount supplied to the heating element from a power supply of a constant voltage through the PWM control. In general, when the heater is controlled through the PWM control, the duty ratio is controlled so as to maintain the heater at a target temperature (a set temperature). The duty ratio is controlled by a method in which the duty ratio is determined based on various factors including the set temperature, a difference between the set temperature and the present temperature, the gradient of temperature change, time that has elapsed and the like or a method in which the duty ratio is determined based on a pattern which is set in advance. Incidentally, a control is carried out such that the duty ratio is set high to obtain warming heat as quickly as possible when the heater is activated. Here, since the object of the heater control apparatus of this illustrative embodiment is that the heat generation amount is not changed by the resistance value (temperature) of the heating element, the inventive concept of the present invention may be applied to any case where the duty ratio is determined by any method. For example, for the cases where the duty ratio is determined by the various methods described above, the duty ratio may be increased or decreased according to a change in resistance value of the heating element.

Further, as long as the electric energizing amount supplied to the heating element can be increased or decreased, any other control than the PWM control may be employed. For example, the time during which the energization of the heating element is on and off may be controlled or the voltage or electric current to be applied may be increased or decreased according to a change in resistance value of the heating element.

Next, there will be described a case where a temperature detection element 31 is provided as the resistance detection unit 3, and this temperature detection element 31 includes a thermistor which is provided to be in contact with the heater 21, whereby a value indicating the temperature of the heater 21 is detected as an electricity amount which corresponds to a resistance value of the heater 21. If a characteristic of the heating element such as a resistance value, temperature coefficient of resistance or the like at a certain temperature is known, the control unit 4 can obtain the present resistance value of the heating element from the temperature of the heater 21 which is detected by the temperature detection element 31 based on, a conversion table, for example.

The heater control apparatus 1 and the heaters 21, 22 are configured to be fed from the on-board generator and the battery of the vehicle. Since the electric power that is generated by the on-board generator or the like is limited, electric power which can be supplied to the heater may be set in advance within the range of a capacity of the power supply when the resistance value of the heating element is a predetermined resistance value (hereinafter, referred to as “suppliable electric power” or “maximum electric power”), and the maximum electric power may be referred to as electric power which is supplied to the heating element when the resistance value of the heating element is minimum in the usable temperature range.

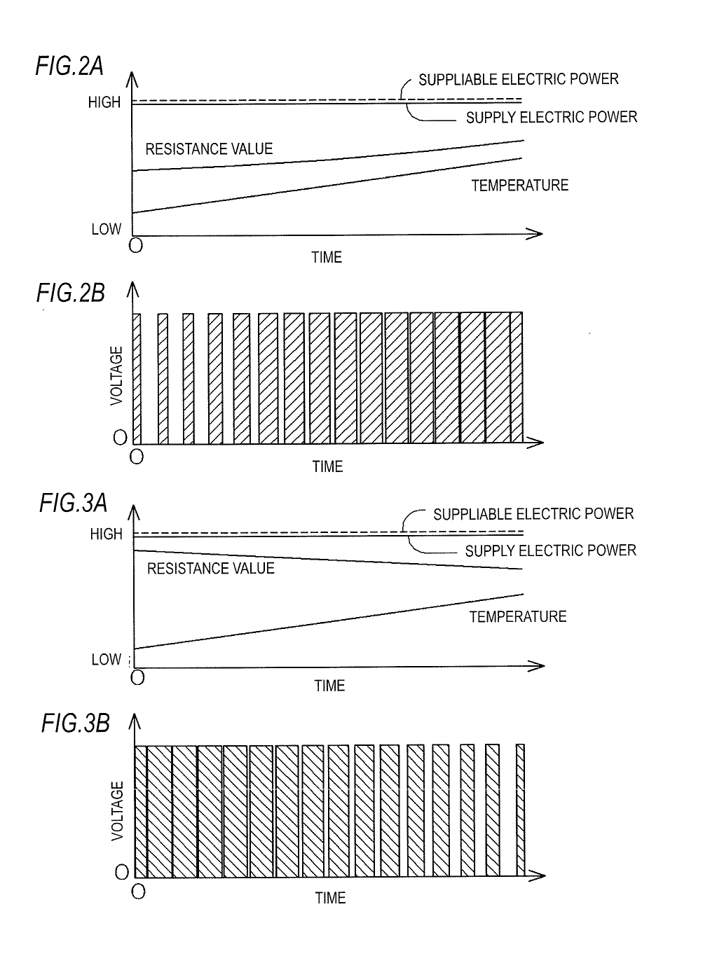

FIGS. 2A and 2B show graphs describing changes in temperature and resistance value of a heating element and changes in voltage and electric power supplied to the heating element in a heater control for the heating element 1 having a positive temperature coefficient of resistance. This example described in FIG. 2 shows a case where even though the resistance value of the heating element increases as the temperature of the heating element increases after the heater is activated, the maximum electric power (the suppliable electric power) is supplied to the heating element.

In the case where the heating element is formed of a material having a positive temperature coefficient of resistance such as copper, the control unit 4 obtains the present resistance value basted on the temperature of the heating element which is detected by the resistance detection unit 3 and changes the duty ration such that the duty ratio increases when the resistance value increases, whereby the electric energizing amount can be controlled so as to compensate for a reduction in electric power which is supplied to the heating element.

Specifically, as shown in FIG. 2A, when the heating element is energized whereby the temperature thereof is increased, the resistance value of the heating element increases as the temperature increases. At this time, if the duty ratio remains constant, the electric current supplied to the heating element decreases, and the electric power supplied to the heating element decreases. Therefore, as shown in FIG. 2B, the duty ratio is increased by such an extent that the resistance value is increased so as to expand the width of the pulse of the applied voltage, whereby the electric power supplied to the heating element is suppressed from being decreased. By performing this control, a constant amount (a maximum amount) of electric power can be supplied to the heating element at all times irrespective of the temperature of the heating element.

In this example, while the duty ratio is changed so as to supply the maximum electric power at all times, by increasing or decreasing the duty ratio based on a duty ratio which is determined from the set temperature or the like, even though the PWM control is performed by any method to control the temperature of the heater, it is possible to correct only a change in resistance value of the heating element.

FIGS. 3A and 3B show graphs describing changes in temperature and resistance value of a heating element and changes in voltage and electric power supplied to the heating element in a heater control for the heating element 1 having a negative temperature coefficient of resistance. This example described in FIGS. 3A and 3B show a case where even though the resistance value of the heating element decreases as the temperature of the heating element increases after the heater is activated, the electric power supplied to the heating element can be maintained to the maximum electric power (the suppliable electric power).

In the case where the heating element is formed of a material having a negative temperature coefficient of resistance such as carbon, the control unit 4 obtains the present resistance value basted on the temperature of the heating element which is detected by the resistance detection unit 3 and changes the duty ration such that the duty ratio decreases when the resistance value decreases, whereby the electric energizing amount can be controlled so as to suppress the increase in electric power which is supplied to the heating element.

Specifically, as shown in FIG. 3A, when the heating element is energized whereby the temperature thereof is increased, the resistance value of the heating element decreases as the temperature increases. As this time, if the duty ratio remains constant, the electric current supplied to the heating element increases, and the electric power supplied to the heating element increases. Therefore, as shown in FIG. 3B, the duty ratio is decreased by such an extent that the resistance value is decreased so as to narrow the width of the pulse of the applied voltage, whereby the electric power supplied to the heating element can be made not to exceed the suppliable electric power. By performing this control, a constant amount of electric power can be supplied to the heating element at all times within the range of the maximum electric power irrespective of the temperature of the heating element, thereby making it possible to maintain the heating value at a constant level.

In this example, while the duty ratio is changed so as to supply the maximum electric power at all times, by increasing or decreasing the duty ratio based on the duty ratio which is determined from the set temperature or the like, even though the PWM control is executed by any method to control the temperature of the heater, it is possible to correct only a change in resistance value of the heating element.

As described above, irrespective of the temperature coefficient of resistance of the heating element being positive or negative, by maintaining the electric power supplied to the heating element to the maximum electric power, it is possible to cause the heating element to generate heat at the constant heat generation amount at all times. Accordingly, compared with the related-art heater control (refer to FIGS. 7A and 7B) in which the electric power to be supplied is controlled without taking the change in resistance value of the heating element into consideration, in the illustrative embodiment of the present invention, the heating element is caused to reach the target temperature in a shorter period of time by fully utilize the electric power which is supplied from the on-board generator.

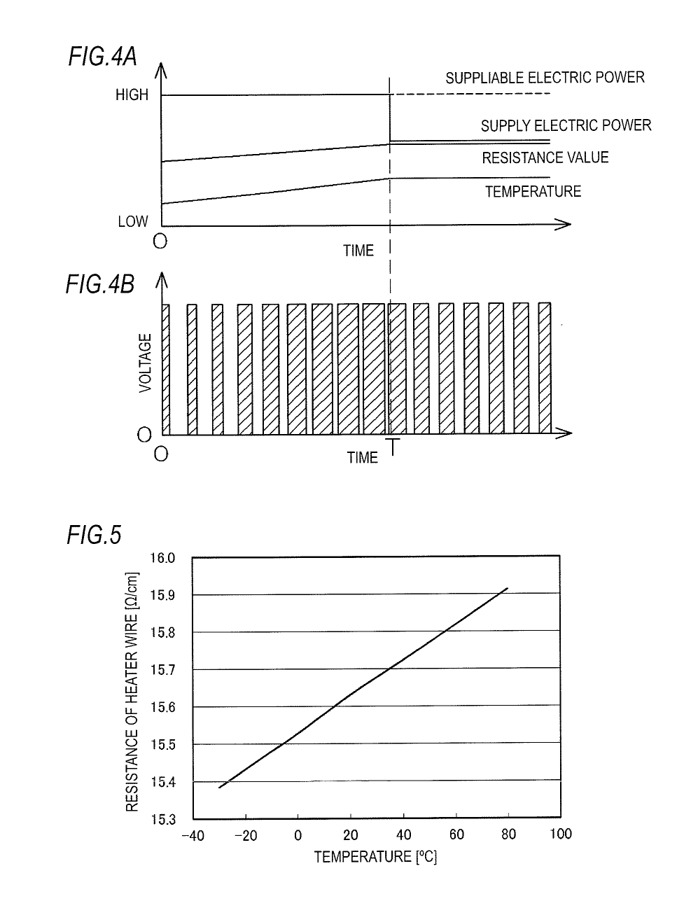

In addition, when the heating element reaches the set temperature which is the target temperature, the set temperature can be maintained by using a known control method. For example, as shown in FIGS. 4A and 4B, in a case where the heating element has the positive temperature coefficient of resistance, when the heating element reaches a temperature which is a target temperature at time T, the duty ratio after the time T is set to a value which can maintain the temperature, whereby it is possible to maintain the temperature. Additionally, the temperature can also be maintained by performing a similar control even though the heating element has the negative temperature coefficient of resistance. Also, when the set temperature is maintained in this manner, by correcting the duty ratio according to a change in resistance value of the heating element based on the set duty ratio, the temperature of the heating element can be controlled more accurately. In addition, since the maximum electric power can be supplied at all times irrespective of the temperature of the heating element, when the temperature of the heating element decreases to a temperature below the target temperature, the heating element can be heated to the target temperature as quickly as possible.

Thus, as exemplified by the above illustrative embodiment, with the control unit 4, when the resistance value of the heating element is any resistance value, the maximum electric power determined within the capacity of the power supply can be supplied to the heating element. The heating element has a certain resistance value at a certain temperature. For example, it is possible to fully utilize the capacity of the power supply irrespective of the temperature of the heating element by adopting the configuration that the maximum electric power can be supplied to the heating element at an upper limit temperature of the usable temperature range when the temperature coefficient of resistance of the heating element is positive or at a lower limit temperature of the usable temperature range when the temperature coefficient of resistance is negative. Accordingly, the heating element can be made to reach the target temperature more quickly than with the related-art heater control.

The description that has been made heretofore is intended only to describe the invention and is hence not construed as limiting the present invention. While the present invention has been described by taking the typical illustrative embodiment for example, the words, phrases or sentences which are used to describe or illustrate the present invention should be understood not to be restrictive but to be descriptive or illustrative. As described in detail herein, the illustrative embodiment can be modified within the scope of appended claims without departing from the spirit and scope of the invention. While the specific constructions, materials and embodiment are referred to herein in the detailed description of the invention, there is no intention to limit the present invention to the matters disclosed herein, and hence, the present invention includes all equivalent constructions, methods and applications which fall within the scope of the appended claims.

What is claimed is:

1. A heater control apparatus for controlling a heat generation amount of a heater including a heating element which is provided in a seat and which has a positive or negative temperature coefficient of resistance, the heater control apparatus comprising:
a resistance detection unit which detects an electricity amount which corresponds to a resistance value of the heating element; and
a control unit which increases or decreases an electric energizing amount supplied to the heating element according to the resistance value obtained by the resistance detection unit.

2. The heater control apparatus according to claim 1,
wherein the heating element has a positive temperature coefficient of resistance, and
wherein the control unit controls electric power supply to the heating element through a PWM control and compensates for the electric energizing amount supplied to the heating element by changing a duty ration to increase when the resistance value obtained by the resistance detection unit is increased.

3. The heater control apparatus according to claim 1,
wherein the heating element has a negative temperature coefficient of resistance, and
wherein the control unit controls electric power supply to the heating element through a PWM control and suppresses the electric energizing amount supplied to the heating element by changing a duty ratio to decrease when the resistance value obtained by the resistance detection unit is decreased.

4. The heater control apparatus according to claim 1,
wherein the heater is supplied with electric power from a predetermined power supply, and
wherein the control unit is capable of supplying, to the heating element, a maximum amount of electric power which is determined within a capacity of the power supply when the heating element has a predetermined resistance value.
